(19) United States
(12) Patent Application Publication
(10) Pub. No.: US 2026/0113819 A1
(43) Pub. Date: Apr. 23, 2026

(54) APPARATUS FOR MANUFACTURING DISPLAY DEVICE AND METHOD OF MANUFACTURING DISPLAY DEVICE USING THE SAME

(71) Applicant: Samsung Display Co., LTD., Yongin-si (KR)

(72) Inventors: JUNGSEON PARK, Yongin-si (KR); MYUNGGIL CHOI, Yongin-si (KR)

(21) Appl. No.: 19/323,396

(22) Filed: Sep. 9, 2025

(30) Foreign Application Priority Data
Oct. 17, 2024 (KR) 10-2024-0141961

(51) Int. Cl. H05B 33/10; B32B 37/00; B32B 37/10; B32B 37/20; B32B 38/18

(52) U.S. Cl. CPC H05B 33/10; B32B 37/0046; B32B 37/10; B32B 38/1858; B32B 2307/202; B32B 2307/584; B32B 2457/206

(57) ABSTRACT

An apparatus for manufacturing a display device includes a stage, a first film processing part which transfers a first film positioned above the stage in one direction, a second film processing part which transfers a second film positioned above the first film in the one direction, a head positioned above the second film, where the head moves in a direction closer to the stage to provide a pressing force to the first film and the second film, and a chucking part which chucks a portion of the second film.

This application claims priority to Korean Patent Application 10-2024-0141961, filed on Oct. 17, 2024, and all the benefits accruing therefrom under 35 U.S.C. § 119, the content of which in its entirety is herein incorporated by reference.

### BACKGROUND

### 1. Field

The disclosure relates to an apparatus for manufacturing a display device. More specifically, the disclosure relates to an apparatus for manufacturing a display device in a bonding process and a method of manufacturing a display device using the apparatus for manufacturing the display device..

### 2. Description of the Related Art

With the development of information technology, the importance of display devices, which are the medium of connection between users and information, is being highlighted. As a result, display devices such as liquid crystal display devices (“LCDs”), organic light-emitting display devices (“OLEDs”), and plasma display devices (“PDPs”) are widely used in various fields.

A display device may include a display area that displays an image and a peripheral area that extends from the display area to one side and where components (e.g., a circuit board, or the like) are located. For example, the circuit board may be formed of a printed circuit board or a film and located on a pad portion of the display panel.

A bonding apparatus may refer to a heat-compression device that attaches the components to a substrate using an anisotropic conductive film. Through a bonding process using the bonding apparatus, a conductive pattern on the substrate and a conductive pattern on the component may be electrically connected to each other.

### SUMMARY

Embodiments provide an apparatus for manufacturing a display device with improved reliability.

Other embodiments provide a method of manufacturing a display device using the apparatus for manufacturing the display device.

An apparatus for manufacturing a display device according to embodiments includes: a stage, a first film processing part which transfers a first film positioned above the stage in one direction, a second film processing part which transfers a second film positioned above the first film in the one direction, a head positioned on the second film, where the head moves in a direction closer to the stage to provide a pressing force to the first film and the second film, and a chucking part which chucks a portion of the second film.

In an embodiment, the chucking part may include a vacuum chuck.

In an embodiment, the chucking part may include a first chuck which chucks a first end of the second film and a second chuck which chucks a second end of the second film opposite to the first end.

In an embodiment, the chucking part may include only one chuck which chucks one of a first end of the second film and a second end of the second film opposite to the first end.

In an embodiment, in a standby state where the head does not provide the pressing force to the first film and the second film, the head and the second film may not contact each other, and the chucking part and the second film may contact each other.

In an embodiment, an object to be processed may be located on the stage, and the object to be processed may include a display panel included in the display device.

In an embodiment, the first film may be an anisotropic conductive film, and the second film may be a protective film.

An apparatus for manufacturing a display device according to embodiments includes: a stage, a first film processing part which transfers a first film positioned above the stage in one direction, a second film processing part which transfers a second film positioned above the first film in the one direction, and a head positioned on the second film, where the head moves in a direction closer to the stage to provide a pressing force to the first film and the second film, and the head includes a body part and a chuck disposed in a hole defined in the body part, where the chuck chucks a portion of the second film.

In an embodiment, the chuck may include a vacuum chuck which provides a vacuum suction force to the second film.

In an embodiment, the body part may include a first region and a second region, the first region may be defined as an area which overlaps the first film, and the second region may be defined as an area which does not overlap the first film, and the chuck may be located in the second region.

In an embodiment, in a standby state where the head does not provide the pressing force to the first film and the second film, the head and the second film may not contact each other, and the chuck and the second film may not contact each other.

In an embodiment, an object to be processed may be located on the stage, and the object to be processed may include a display panel included in the display device.

In an embodiment, the first film may be an anisotropic conductive film, and the second film may be a protective film.

A method of manufacturing a display device according to embodiments includes: disposing an object to be processed on a stage, disposing a first film above the object to be processed, disposing a second film, a portion of which is chucked, above the first film, pressuring the first film and the second film to contact the object to be processed, and separating the second film from the object to be processed.

In an embodiment, the portion of the second film may be chucked by vacuum suction.

In an embodiment, the portion of the second film may be opposite ends of the second film.

In an embodiment, the portion of the second film may be one end of the second film.

In an embodiment, the object to be processed may include a display panel included in a display device.

In an embodiment, the first film may be an anisotropic conductive film, and the second film may be a protective film.

In an embodiment, the first film may be provided in plural, and a plurality of the first films may be attached on the object to be processed.

The apparatus for manufacturing the display device and the method of manufacturing the display device using the apparatus for manufacturing the display device according to embodiments of the disclosure may effectively prevent an occurrence of a defect due to the slip of the protective film when performing compression by the head by chucking the portion of the protective film.

### BRIEF DESCRIPTION OF THE DRAWINGS

The above and other features of embodiments of the disclosure will become more apparent by describing in further detail embodiments thereof with reference to the accompanying drawings, in which:

FIGS. 1 and 2 are views illustrating an apparatus for manufacturing a display device according to an embodiment of the disclosure.

FIGS. 3, 4, 5, 6, and 7 are views illustrating a method of manufacturing a display device using the apparatus for manufacturing the display device of FIGS. 1 and 2.

FIGS. 8, 9, 10, and 11 are views illustrating a display device manufactured using the apparatus for manufacturing the display device of FIGS. 1 and 2.

FIG. 12 is a top view of the display panel included in the display device of FIGS. 10 and 11.

FIG. 13 is a cross-sectional view along X-X′ line of FIG. 12.

FIGS. 14 and 15 are views illustrating an apparatus for manufacturing the display device and a method of manufacturing the display device using the apparatus according to another embodiment of the disclosure.

FIGS. 16, 17, and 18 are views illustrating an apparatus for manufacturing the display device and the method of manufacturing the display device using the apparatus according to another embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described in detail with reference to the accompanying drawings. The drawings will use the same reference numerals for the same components, and any repetitive detailed descriptions of the same components will be omitted or simplified.

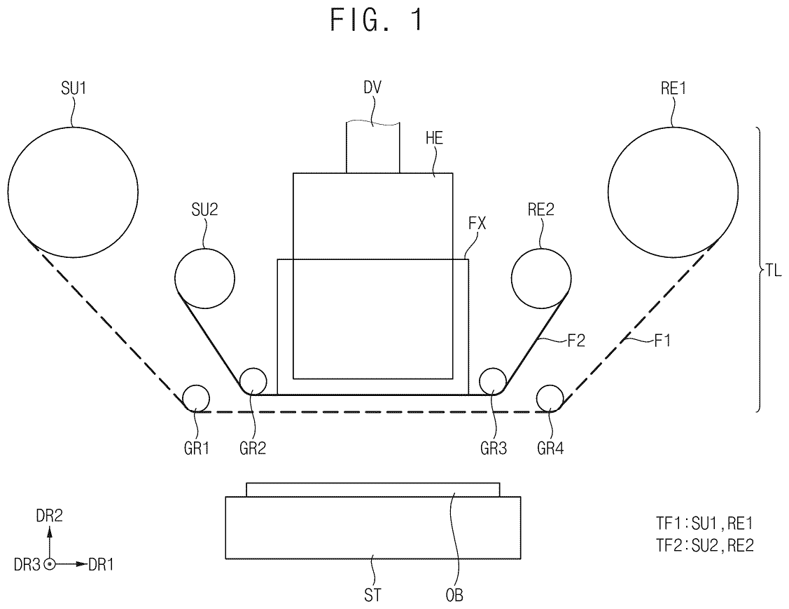

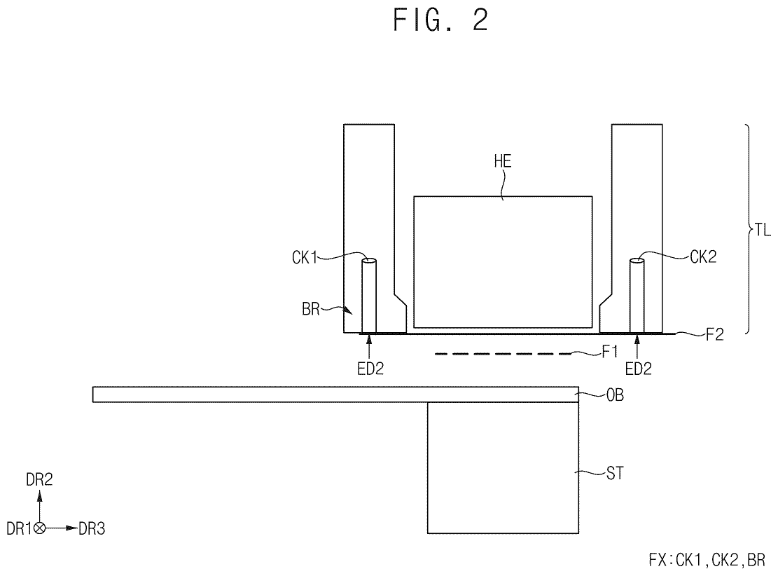

FIGS. 1 and 2 are views illustrating an apparatus for manufacturing a display device according to an embodiment of the disclosure.

Particularly, FIG. 1 is a top view of the apparatus for manufacturing the display device according to an embodiment of the disclosure, and FIG. 2 is a side view of the apparatus for manufacturing the display device according to an embodiment of the disclosure.

The apparatus for manufacturing the display device according to an embodiment of the disclosure may include a stage ST and a bonding device TL disposed on the stage.

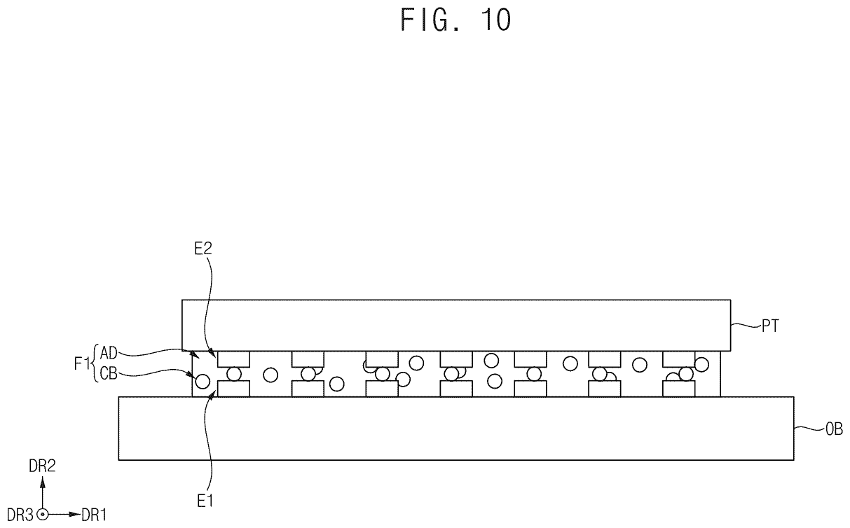

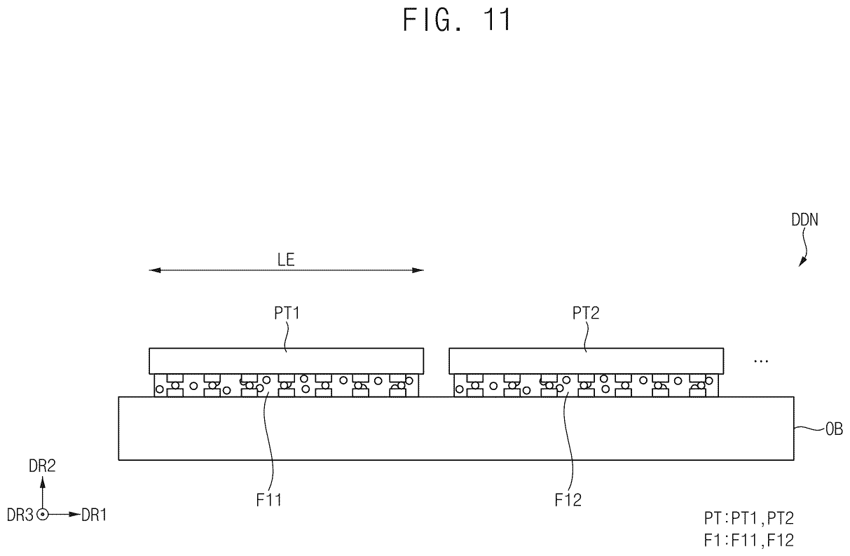

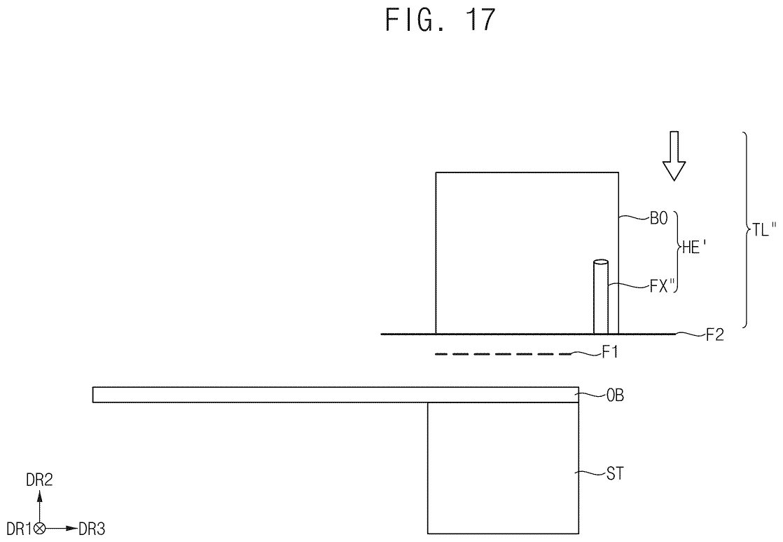

In an embodiment, an object to be processed OB may be located on the stage ST. In an embodiment, for example, the object to be processed OB may be an object of a bonding process (thermal-compression bonding). In an embodiment, the object OB to be processed may include a display panel (e.g., a display panel PA of FIG. 17) included in a display device (e.g., a first display device DD1 of FIG. 10 or a N^{th} display device DDN of FIG. 11).

In an embodiment, for example, the bonding device TL may be a device that heat-compresses and bonds a first film F1 to the display panel. In an embodiment, the bonding device TL may include a first film processing part TF1, a second film processing part TF2, a head HE, and a chucking part FX.

In an embodiment, the first film processing part TF1 may be located above the stage ST. The first film processing part TF1 may be disposed on opposite sides of the first film F1. The first film processing part TF1 may transport the first film F1 positioned above the object to be processed OB in one direction.

In an embodiment, for example, the first film processing part TF1 may include a first supply part SU1 and a first recovery part RE1. In an embodiment, for example, the first film F1 in contact with the object to be processed OB may be provided from the first supply part SU1. A contaminated or used first film F1 may be recovered in the first recovery part RE1. In an embodiment, for example, the first film F1 may move in a first direction DR1 in a region overlapping the object to be processed OB. In an embodiment, for example, the first film F1 may be provided for each bonding process.

In an embodiment, the first film F1 may be an anisotropic conductive film (“ACF”). In an embodiment, for example, the anisotropic conductive film may include an adhesive layer and a release paper. The release paper may be a film that protects the adhesive layer. The release paper may be removed during the bonding process, and only the adhesive layer may be attached to the object to be processed OB.

In an embodiment, a second film processing part TF2 may be located above the first film processing part TF1. The second film processing part TF2 may be disposed on opposite sides of a second film F2. The second film processing part TF2 may transport the second film F2 positioned above the first film F1 in the one direction. In an embodiment, for example, the second film processing part TF2 may include a second supply part SU2 and a second recovery part RE2. In an embodiment, for example, while unwinding the first film F1 wound in a roll form in the second supply part SU2, the second film F2 in contact with the first film F1 may be provided. After the heat-compression bonding process, the second film F2 may be separated from the object to be processed OB. In addition, a contaminated or used second film F2 may be recovered to the second recovery part RE2 (“reel to reel method”).

In an embodiment, for example, the second film F2 may be provided about every tens of times. In an embodiment, for example, the second supply part SU2 may provide the second film F2 to the object to be processed OB, and a used second film F2 may be recovered and discharged from the second recovery part RF2. Accordingly, the amount of the second film F2 wound around the second supply part SU2 may gradually decrease. In case that the amount of the second film F2 wound around the second supply part SU2 is insufficient, a new second film F2 may be supplied to the second supply part SU2.

In an embodiment, the second film F2 may be a protective film. The protective film may serve as a buffer during the bonding process. In an embodiment, for example, the protective film may effectively prevent damage to the bonding device TI, effectively prevent damage to the object to be processed OB, and relieve flatness.

In an embodiment, the head HE may be located above the second film F2. Effectively example, the head HE may move in a direction closer to the stage ST (e.g., a second direction DR2) or in a direction away from the stage ST (e.g., an opposite direction to the second direction DR2). The second direction DR2 may cross the first direction DR1. Effectively example, the first direction DR1 and the second direction DR2 may be perpendicular to each other.

In an embodiment, the head HE may move in the direction closer to the stage ST (e.g., the second direction DR2) to provide pressing force or a pressure to the first film F1 and the second film F2.

In an embodiment, for example, the head HE may include a metal. In case that the head HE provides the pressing force, a foreign material, or the like, may be present on a pressing surface of the head HE and/or an attachment surface of the object OB to be processed (a surface opposite the pressing surface). In case that the second film F2 is not located, the head HE and/or the first film F1 may be damaged when the pressing force is applied. To prevent such a damage to the head HE and/or the first film F1, the second film F2 may be disposed between the head HE and the first film F1.

In an embodiment, the chucking part FX may include a first chuck CK1, a second chuck CK2, and a bracket BR. In an embodiment, for example, the bracket BR may support the first chuck CK1 and the second chuck CK2. In an embodiment, for example, the first chuck CK1 and the second chuck CK2 may be spaced apart from each other in a third direction DR3. Here, the third direction DR3 may cross both the first direction DR1 and the second direction DR2. For example, the third direction DR3 may be perpendicular to both the first direction DR1 and the second direction DR2.

In an embodiment, the chucking part FX may chuck (or apply a chucking force to) a portion of the second film F2 to effectively prevent tension weakening and slipping of the second film F2. The second film F2 may include a different material from the first film F1. In an embodiment, for example, the second film F2 may include an elastic body. In an embodiment, for example, the elastic body may include silicone, Teflon®, or the like. In addition, the second film F2 may have a longer moving distance than the first film F1. Accordingly, as the size of the second film F2 increases, sagging may occur in the second film F2 in a gravity direction. In addition, the slip may occur the second film F2 while the second film F2 moves. The chucking portion FX may effectively prevent the sagging and slipping of the second film F2 by chucking the portion (e.g., end portion) of the second film F2.

In an embodiment, the first chuck CK1 and/or the second chuck CK2 included in the chucking part FX may be a vacuum chuck. However, the disclosure is not limited thereto. In an embodiment, for example, the chuck that may effectively prevent the second film F2 from slipping may be used in various ways. In an embodiment, for example, the first chuck CK1 and/or the second chuck CK2 may include an electrostatic chuck. In addition, the first chuck CK1 and the second chuck CK2 may each include a same type of chuck or include different types of chucks, respectively.

In an embodiment, the chucking part FX may include a first chuck CK1 that chucks a first end ED1 of the second film F2 and a second chuck CK2 that chucks a second end ED2 opposite the first end ED1. In an embodiment, for example, in a plan view, the first chuck CK1 and the second chuck CK2 may be disposed at a position where the first chuck CK1 and the second chuck CK2 do not overlap the first film F1 but only overlap the second film F2. Accordingly, the first film F1 may attached to the object to be processed OB through the bonding process, and the second film F2 may maintain the tension thereof.

In an embodiment, in a standby state, the head HE does not contact the second film F2, and the chucking part FX and the second film F2 may contact each other. In an embodiment, for example, the head HE may have a high temperature. In an embodiment, for example, the temperature of the head HE may be about 60 degrees or higher. In an embodiment, the head HE and the second film F2 may be spaced apart to effectively prevent the deformation of the second film F2 due to the heat. In an embodiment, the chucking part FX may be in a state of chucking (or applying a chucking force to) the second film F2. In an embodiment, defects due to the slip of the second film F2 may be effectively prevented by a chucking part FX further included in a bonding device.

The embodiment shown in FIG. 1 is illustrative and the disclosure is not limited thereto. In an embodiment, for example, the apparatus for manufacturing the display device may include more components, or some of the components may be replaced/omitted.

In an embodiment, for example, a driving device DV may be further included to drive the head HE. The driving device DV may move the head HE in the second direction DR2 and/or in an opposite direction to the second direction DR2. In an embodiment, for example, the driving device DV may include a servo motor. However, the disclosure is not limited thereto.

In an embodiment, for example, the head HE may include a cylinder. The cylinder may be located at a front of the driving device DV (the opposite direction to the first direction DR1). The cylinder may provide pressing force or a pressure to the object to be processed OB.

In addition, guide rollers (e.g., GR1, GR2, GR3, and GR4 of FIG. 1) that guide a movement of the first film F1 and the second film F2 may be further included. The guide roller may have a tolerance (e.g., a manufacturing tolerance of the guide roller). Slip of the second film F2 may occur due to the tolerance.

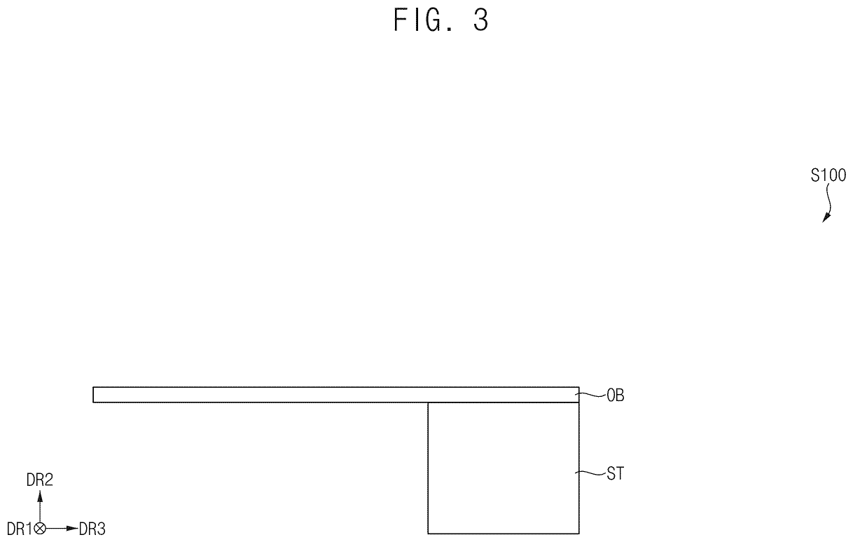

FIGS. 3, 4, 5, 6, and 7 are views illustrating a method of manufacturing a display device using the apparatus for manufacturing the display device of FIGS. 1 and 2.

Hereinafter, for convenience of description, any repetitive detailed descriptions of the same or like elements as those of the apparatus for manufacturing the display device according to the embodiment of the disclosure described above with reference to FIGS. 1 and 2 will be omitted or simplified.

Referring to FIG. 3, in the method of manufacturing a display device according to an embodiment of the disclosure, the object to be processed OB may be located (or provided) on the stage ST (S100). In an embodiment, the object to be processed OB may include the display panel included in the display device.

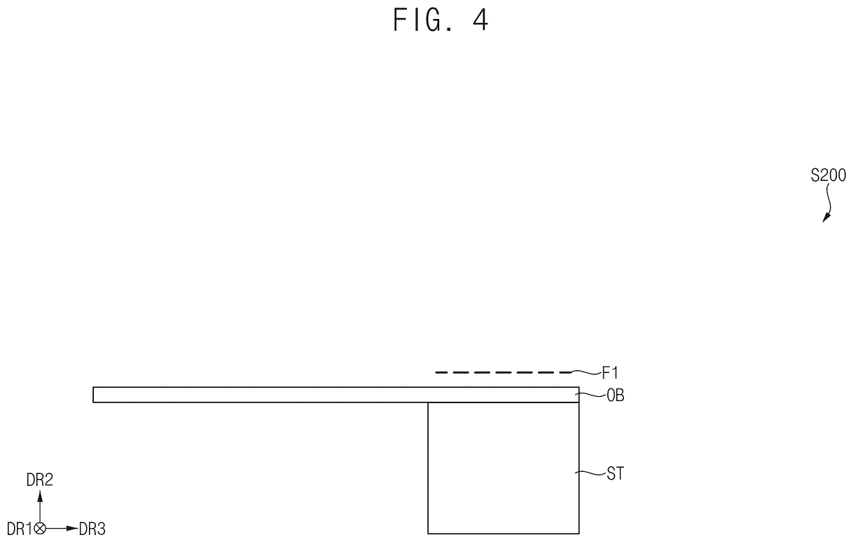

Referring to FIG. 4, the first film F1 may be located (or provided) above the object OB (S200). In an embodiment, the first film F1 may be an anisotropic conductive film.

In an embodiment, for example, a top may be in the second direction DR2 (e.g., an opposite direction to the gravity direction). The object to be processed OB and the first film F1 may be parallel to a plane defined by the first direction DR1 and the third direction DR3.

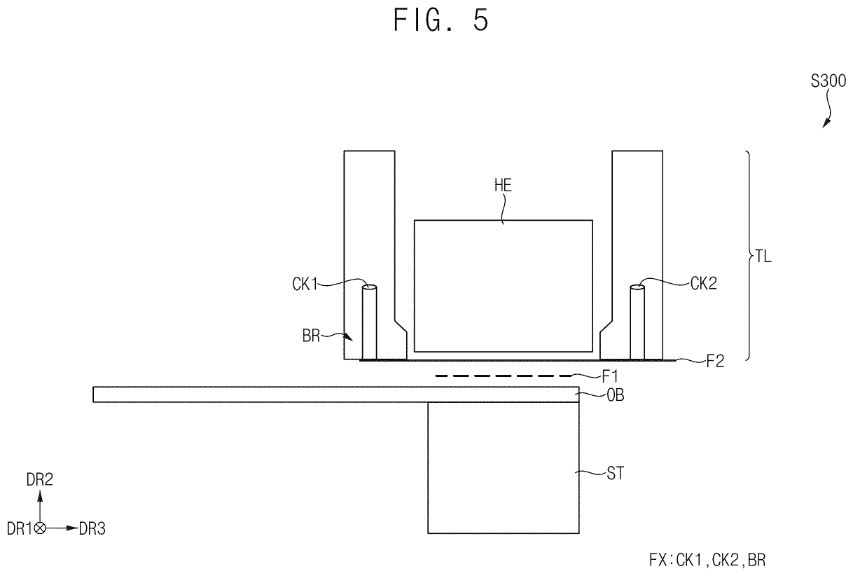

Referring to FIG. 5, the partially chucked second film F2 may be located (or provided) above the first film F1 (S300). In an embodiment, the second film F2 may be a protective film.

In an embodiment, the portion of the second film F2 may be opposite ends of the second film F2 (e.g., ED1 and ED2 of FIG. 2). In an embodiment, the portion of the second film F2 may be chucked by the chucking part FX using vacuum adsorption. In an embodiment, for example, the chucking part FX may include the first chuck CK1 and a second chuck CK2 supported by the bracket BR. The first chuck CK1 and the second chuck CK2 may take up and hold opposite ends (e.g., ED1 and ED2 of FIG. 2) of the second film F2 using vacuum pressure. Accordingly, it is possible to effectively prevent the sagging of the second film F2 in the opposite direction to the second direction DR2 and the occurrence of the slip when moving along the guide rollers (e.g., GR1, GR2, GR3, and GR4 of FIG. 1).

As described above, in an embodiment, the second film F2 may contact the chucking par FX and not contact the head HE when the partially chucked second film F2 is located (or provided) above the first film F1 to effectively prevent the thermal deformation of the second film F2.

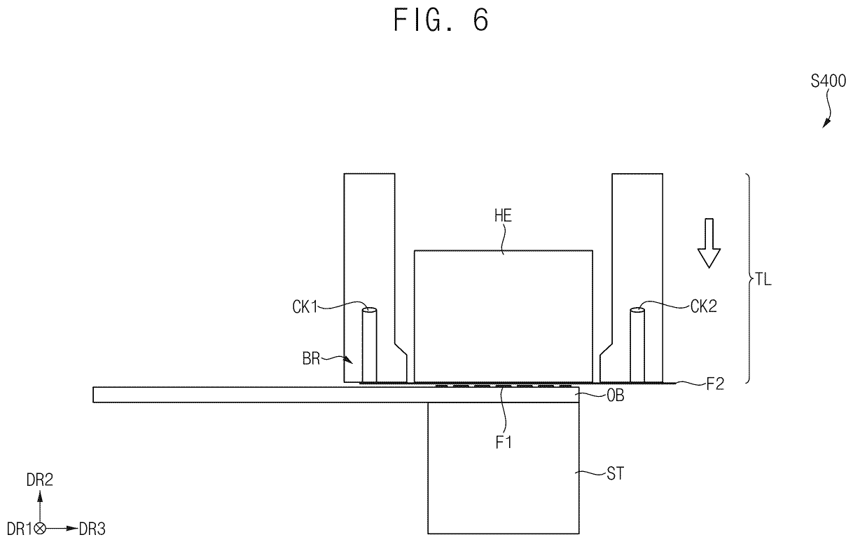

Referring to FIG. 6, the first film F1 and the second film F2 may be pressed and brought into contact with the object to be processed OB (S400). In this process, only the adhesive layer of the first film F1 maybe attached to the object to be processed OB, and the release paper may be removed.

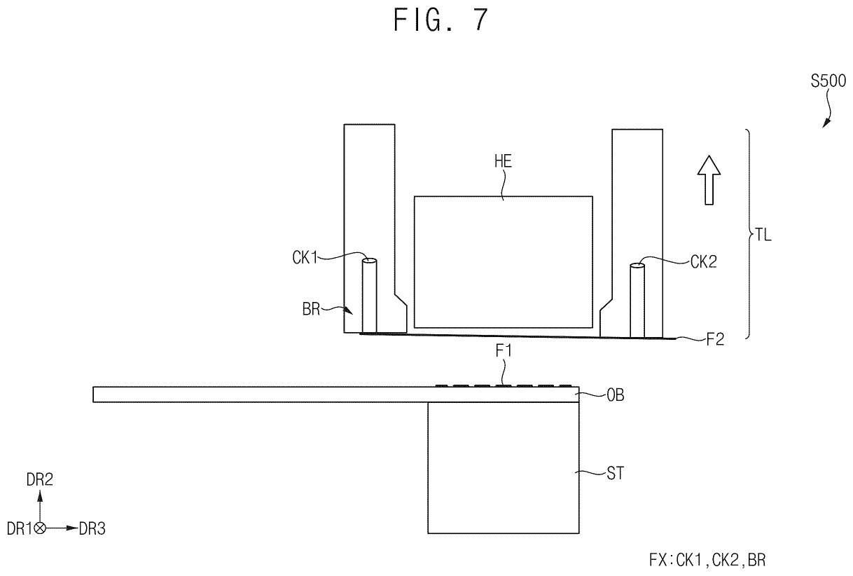

Referring to FIG. 7, the second film F2 may be separated from the processing object OB (S500). In order to proceed with a new bonding process, a new first film F1 may be provided to the first film processing part (e.g., the first film processing part TF1 of FIG. 1). In an embodiment, for example, after the second film F2 has been subjected to (or used for) the bonding process dozens of times, a new second film F2 may be provided to the second film processing part (e.g., the second film processing part TF2 of FIG. 1).

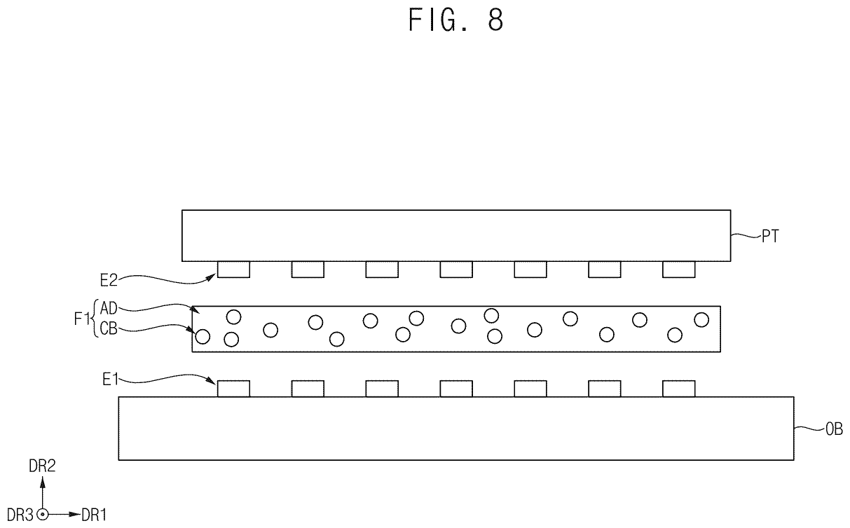

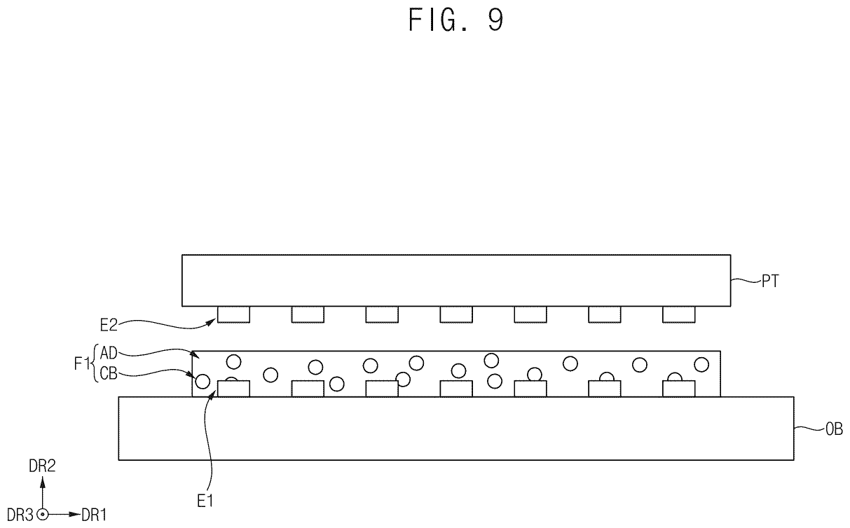

FIGS. 8, 9, 10, and 11 are views illustrating a display device manufactured using the apparatus for manufacturing the display device of FIGS. 1 and 2.

Hereinafter, for convenience of description, any repetitive detailed descriptions of the same or like elements as those of the apparatus for manufacturing the display device according to the embodiment of the disclosure described above with reference to FIGS. 1 and 2 and as those of the method of manufacturing the display device according to the embodiment described above with reference to FIGS. 3, 4, 5, 6, and 7 will be omitted or simplified.

Referring to FIGS. 8, 9, and 10, the first display device DD1 may include the object to be processed OB, the first film F1, and a component PT. In an embodiment, for example, the object to be processed OB may include the display panel, the first film F1 may include the anisotropic conductive film, and the component PT may include a circuit board. However, the disclosure is not limited thereto.

In an embodiment, for example, the bonding device TL of FIG. 1 may be a device that applies heat and pressure to the first film F1 to electrically connect a first electrode E1 of the object to be processed OB and a second electrode E2 of the component PT.

In an embodiment, for example, the first film F1 may include an adhesive AD and a conductive ball CB. The conductive ball CB may be dispersed in (distributed and disposed within) the adhesive AD. In an embodiment, for example, the adhesive AD may include thermoplastic materials (e.g., styrene-butadiene, polyvinyl-butylene, or the like), thermosetting materials (e.g., epoxy resin, polyurethane, acrylic resin, or the like). In an embodiment, for example, the conductive ball CB may include a metal material (e.g., gold (Au), nickel (Ni), palladium (Pd), or the like).

In an embodiment, for example, the conductive ball CB may have a multi-layer structure including a core including a polymer, a metal layer surrounding the core and including a conductive material, and a skin layer surrounding the metal layer and including an insulating material. However, the disclosure is not limited thereto.

In an embodiment, for example, when the first film F1 is heat-compressed between the object to be processed OB and the component PT, electricity may flow in a pressing direction (e.g., the second direction DR2), and the adhesive AD may have insulating properties such that electricity may not flow in a direction perpendicular to the pressing direction (i.e., anisotropic).

Referring to FIGS. 8, 9, and 11, the N^{th} display device DDN may include a plurality of components PT. In an embodiment, for example, a first part PT1 and a second part PT2 may be disposed on the object to be processed OB. To this end, in an embodiment, a plurality of first films F1 may be attached on the object to be processed OB.

As a length LE of the first film F1 in the first direction DR1 increases, the number of bonding processes, a tact time, and the number of parts used in the bonding process (i.e., the number of bonding devices TL of FIG. 2) may decrease. Accordingly, the number of display devices manufactured per unit time (i.e., yield) may be improved. However, as the length LE of the first film F1 in the first direction DR1 increases, the tension at the center may weaken. Accordingly, before the bonding process (i.e., in the standby state), the sagging may occur in the first film F1 in the gravity direction (e.g., the opposite direction to the second direction DR2).

The slip may occur in the first film F1 while moving along the first film processing part TF1. In this case, a surface of the second film F2 may be uneven in a side view, due to the slip (i.e., the flatness of the surface of the second film F2 may be small). In this case, a position where the second film F2 is attached may deviate from a designed position. Accordingly, the yield of the display device may decrease.

The apparatus for manufacturing the display device according to embodiments of the disclosure may include the chucking part (e.g., the chucking part FX of FIG. 2). The tension weakening of the first film F1 may be effectively prevented by chucking the end (e.g., ED1 and/or ED2 of FIG. 2) of the first film F1. Accordingly, the occurrence of the slip may be effectively prevented, such that the yield of the display device may be improved.

In an embodiment, as shown in FIGS. 8, 9, and 10, the first film F1 may be attached to the object to be processed OB and then the component PT may be attached. However, the disclosure is not limited thereto. In another embodiment, for example, after attaching the first film F1 on the component PT, the object to be processed OB may be attached.

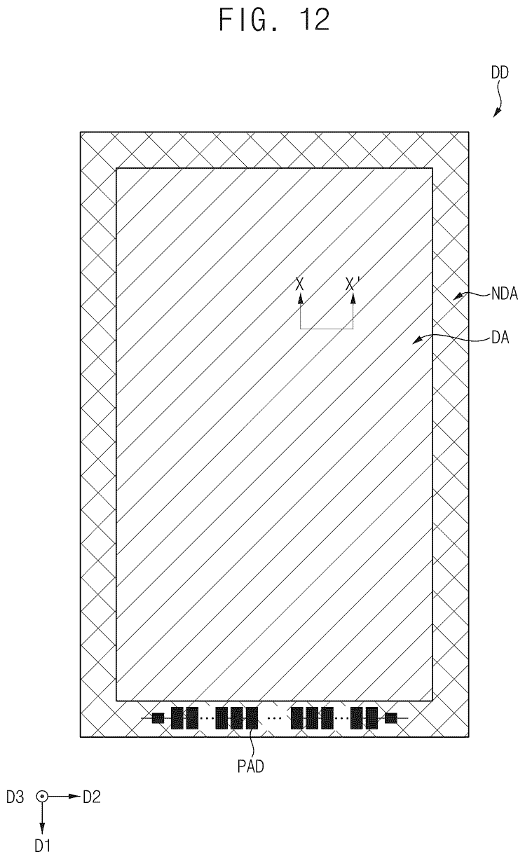

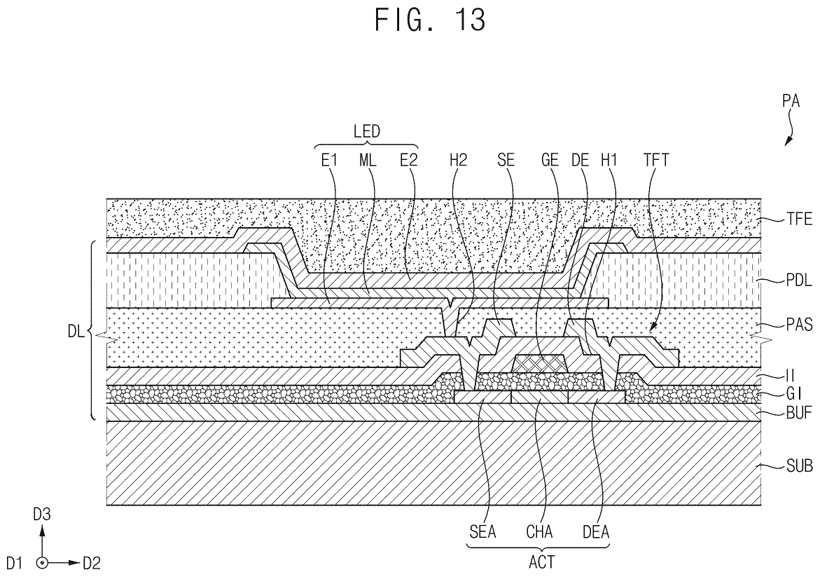

FIG. 12 is a top view of the display panel included in the display device of FIGS. 10 and 11. FIG. 13 is a cross-sectional view along X-X′ line of FIG. 12.

Referring to FIGS. 12 and 13, an embodiment of the display panel PA of the display device DD may include a plurality of layers on a base substrate SUB. In an embodiment, for example, a pixel included in the display panel PA may include the base substrate SUB, a buffer layer BUF, a displaying layer DL, and an encapsulation layer TFE.

The displaying layer DL may include a transistor TFT, a gate insulating layer GI, an interlayer insulating layer II, a passivation layer PAS, a light-emitting element LED, and a pixel defining layer PDL.

A display area DA may include a light-emitting region and a non-light-emitting region. In an embodiment, for example, the transistor TFT and the light-emitting elements LED may be located in the light-emitting region.

In an embodiment, for example, the transistor TFT may include an active layer ACT, a gate electrode GE, a source electrode SE, and a drain electrode DE. The light-emitting element LED may include a first electrode E1, an intermediate layer ML, and a second electrode E2.

The non-light-emitting region may surround the light-emitting region in a plan view. Here, the plan view may mean a view along the third direction DR3.

In an embodiment, for example, he base substrate SUB may include glass, quartz, plastic, SUS, titanium (Ti), or the like. In an embodiment, for example, the base substrate SUB may have flexible, bend-able, or roll-able properties.

The buffer layer BUF may be disposed on the base substrate SUB. The buffer layer BUF may include an inorganic insulating material. In an embodiment, for example, the buffer layer BUF may include silicon oxide, silicon nitride, silicon oxide, or the like. The buffer layer BUF may prevent an impurity from being diffused into or damaging the active layer ACT of the transistor TFT. However, the disclosure is not limited thereto. In an embodiment, for example, the buffer layer BUF may include an organic insulating material.

The active layer ACT may be disposed on the buffer layer BUF. According to an embodiment, the active layer ACT may include a silicon semiconductor material. In an embodiment, for example, the active layer ACT may include amorphous silicon, polycrystalline silicon, or the like. According to an embodiment, the active layer ACT may include oxide semiconductor material. In an embodiment, for example, the active layer ACT may include zinc oxide, zinc-tin oxide, zinc-indium-oxide, indium-oxide, titanium-oxide, indium-gallium-zinc-oxide, indium-zinc-tin-oxide, or the like. According to an embodiment, the active layer ACT may include an organic semiconductor material.

The active layer ACT may include a source region SEA, a drain region DEA, and a channel region CHA that is interposed between the source region SEA and the drain region DEA.

In an embodiment, for example, the active layer ACT may be formed by forming an amorphous silicon layer on the buffer layer BUF, crystallizing the amorphous silicon layer, and patterning the crystallized silicon layer. In an embodiment, for example, the active layer ACT may be doped with impurities in the source region SEA and drain region DEA, depending on a type of the transistor TFT (for example, driving transistor, switching transistor, or the like).

The gate insulating layer GI may be disposed on the active layer ACT. The gate insulating layer GI may include an inorganic insulating material. In an embodiment, for example, the gate insulating layer GI may include silicon oxide, silicon nitride, silicon oxide, titanium-oxide, tantalum oxide, or the like. The gate insulating layer GI may electrically insulate the active layer ACT from the gate electrode GE from each other.

The gate electrode GE may be disposed on the gate insulating layer GI. The gate electrode GE may include a conductive material. In an embodiment, for example, the gate electrodes GE may include a metal, an alloy, a conductive metal oxide, a transparent conductive material, or the like. The gate electrodes GE may be applied with a gate signal. The gate signal may turn on/off the transistor TFT to adjust an electrical conductivity of the active layer ACT.

The interlayer insulating layer II may be disposed on the gate electrode GE. The interlayer insulating layer II may include an organic and/or an inorganic insulating material. The interlayer insulating layer II may electrically insulate the source electrode SE and the drain electrode DE from the gate electrode GE.

The source electrode SE and drain electrode DE may be disposed on the interlayer insulating layer II. The source electrode SE and the drain electrode DE may include a conductive material. In an embodiment, for example, the source electrode SE and the drain electrode DE may include a metal, an alloy, a conductive metal oxide, a transparent conductive material, or the like.

The source electrode SE and drain electrode DE may be in electrical contact with the active layer ACT through a contact hole H1 defined or formed through the interlayer insulating layer II and the gate insulating layer GI. In an embodiment, for example, the source electrode SE may be connected to the source region SEA and the drain electrode DE may be connected to the drain region DA through a contact hole H1 in the interlayer insulating layer II and gate electrode GE.

The passivation layer PAS may be disposed on the source electrode SE and the drain electrode DE. The passivation layer PAS may include an organic insulating material. In an embodiment, for example, the passivation layer PAS may include a polyacrylic resin, a polyimide-based resin, an acrylic-based resin, or the like. A top surface of the passivation layer PAS may be substantially flat. In an embodiment, for example, the passivation layer PAS may be formed with a transparent insulator to achieve a resonant effect. In an embodiment, for example, the passivation layer PAS may include two or more layers including organic and/or inorganic matter. However, the disclosure is not limited thereto.

In another embodiment, for example, the top surface of the passivation layer PAS may be formed to bend according to a curvature of an underlying layer. In this case, the passivation layer PAS may also include an inorganic insulating material.

The first electrode E1 may be disposed on the passivation layer PAS. The first electrode E1 may include a conductive material. In an embodiment, for example, the first electrode E1 may include a metal, an alloy, a conductive metal oxide, a transparent conductive material, or the like.

The first electrode E1 may be electrically connected to the source electrode SE or the drain electrode DE through a contact hole H2 defined or formed through the passivation layer PAS. According to an embodiment, the first electrode E1 may be referred to as an anode electrode.

The pixel defining layer PDL may be disposed on the passivation layer PAS and cover a portion of the first electrode E1. The pixel defining layer PDL may include an organic insulating material. In an embodiment, for example, the pixel defining layer PDL may include a polyacrylic compound, a polyimide-based compound, or the like. The pixel defining layer PDL may define or be provided with a pixel opening to partition the light-emitting region of the pixel. The pixel opening defined in the pixel defining layer PDL may extend to the first electrode E1.

The intermediate layer ML may be disposed on the first electrode E1 in the pixel opening. The intermediate layer ML may include an organic light-emitting material. According to an embodiment, the intermediate layer ML may have a multi-layered structure including various functional layers. In an embodiment, for example, the intermediate layer ML may include at least one of a hole injection layer, a hole transport layer, an electron transport layer, or an electron injection layer.

The second electrode CE may be disposed on the intermediate layer ML and cover the pixel defining layer PDL. According to an embodiment, the second electrode CE may be referred to as a cathode electrode.

In addition, the intermediate layer ML and the second electrode E2 may be formed on the first electrode E1.

The first electrode E1 and the second electrode E2 may be separated from each other by the intermediate layer ML, and light may be emitted from the organic light-emitting layer by applying voltages of different polarities to the intermediate layer ML. In an embodiment, a unit pixel may include a plurality of sub pixels, and the plurality of sub pixels may emit light of various colors. In an embodiment, for example, each of the plurality of sub pixels may emit any one of red, green, or blue lights. However, the disclosure is not limited thereto. In another embodiment, for example, the plurality of sub pixels may emit white light.

The encapsulation layer TFE may have a multi-layered structure. In an embodiment, for example, the encapsulation layer TFE may include at least one organic layer interposed between at least two inorganic layers. In an embodiment, for example, the encapsulation layer TFE may include at least one inorganic layer interposed between at least two organic layers. In an embodiment, for example, the encapsulation layer TFE may include at least an organic layer interposed between at least two inorganic layers, and at least an inorganic layer interposed between at least two organic layers.

In an embodiment, for example, the encapsulation layer TFE may include an organic layer. In an embodiment, for example, the organic layer may include a polymer. In an embodiment, for example, the polymer may include polyethylene terephthalate, polyimide, polycarbonate, epoxy, polyethylene, polyacrylate, or the like. Each of them may be used alone or in combination with each other. However, the disclosure is not limited thereto. The organic layer may include a material polymerized monomer composition. In an embodiment, for example, the monomer composition may include a mono-acrylate-based monomer, a de-acrylate-based monomer, a tri-acrylate-based monomer, a photo-initiator such as 2,4,6-tri-methylbenzoyl-diphenyl phosphine oxide (TPO), or the like. Each of them may be used alone or in combination with each other. However, the disclosure is not limited thereto.

In an embodiment, for example, the encapsulation layer TFE may include an inorganic layer. In an embodiment, for example, the inorganic layer may include a metal oxide or a metal nitride. In an embodiment, for example, the inorganic layer may include SiNₓ, Al₂O₃, SiO₂, TiO₂, or the like. The materials listed above may be used alone or in combination with each other. However, the disclosure is not limited thereto.

In an embodiment, for example, the encapsulation layer TFE may include a first inorganic layer, a first organic layer, and a second inorganic layer sequentially stacked from a top of the light-emitting element LED. In an embodiment, for example, the encapsulation layer TFE may include the first inorganic layer, the first organic layer, the second inorganic layer, a second organic layer, and a third inorganic layer sequentially stacked from the top of the light-emitting element LED. In an embodiment, for example, the encapsulation layer TFE may include the first inorganic layer, the first organic layer, the second inorganic layer, the second organic layer, the third inorganic layer, a third organic layer, and the fourth inorganic layer sequentially stacked from the top of the light-emitting element LED.

A top layer of the encapsulation layer TFE that is the outermost layer of the display panel PA may be formed with the inorganic layer to prevent the moisture permeation into the light-emitting element LED. However, the disclosure is not limited thereto.

A halide-metal layer may be further included between the light-emitting element LED and the first inorganic layer. In an embodiment, for example, the halide-metal layer may include lithium fluoride (LiF). In case that the forming of the first inorganic layer is performed by sputtering method, the halide-metal layer may effectively prevent the light-emitting element LED from being damaged. However, the disclosure is not limited thereto.

A pad PAD may be a PART where the display panel PA and the circuit board (e.g., the component PT of FIG. 2) may be connected. In an embodiment, for example, the first film (e.g., the first film F1 of FIG. 2) by the described apparatus (method) for manufacturing the display device is disposed in a region where the pad PAD is located, and the display panel PA and the circuit board may be electrically connected by the conductive ball (e.g., the conductive ball CB of FIG. 2) included in the first film F1.

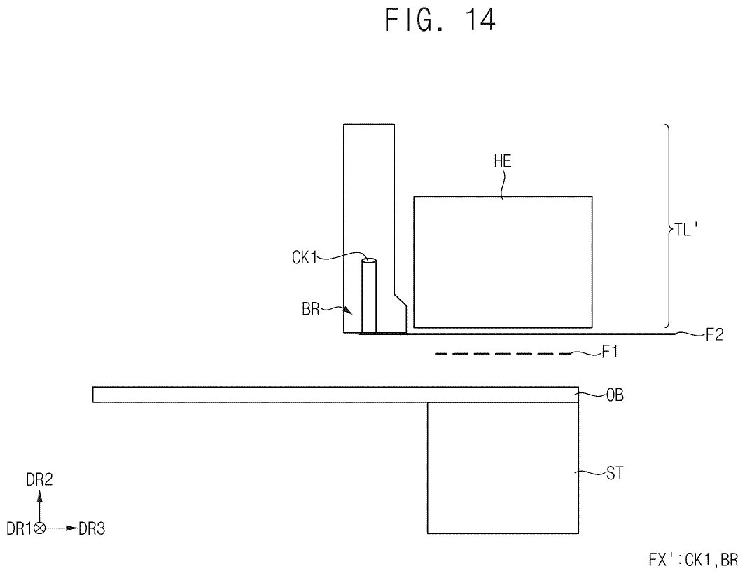

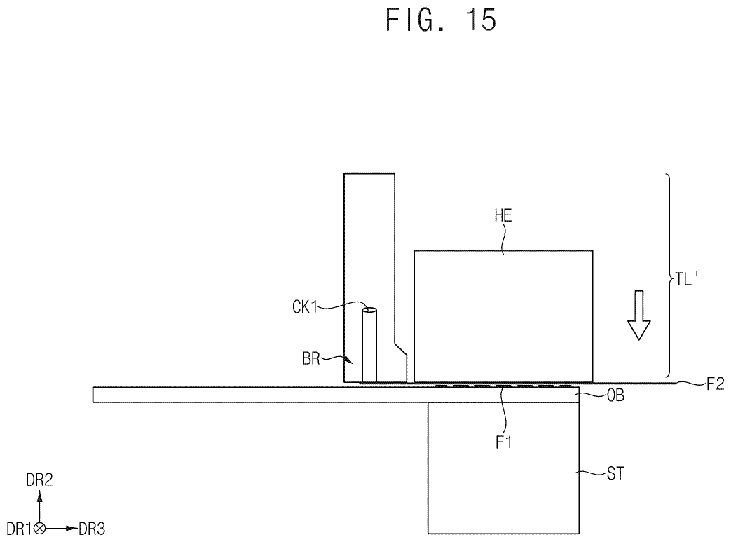

FIGS. 14 and 15 are views illustrating an apparatus for manufacturing the display device and a method of manufacturing the display device using the apparatus according to another embodiment of the disclosure.

Hereinafter, for convenience of description, any repetitive detailed descriptions of the same or like elements as those of the apparatus for manufacturing the display device according to the embodiment of the disclosure described above with reference to FIGS. 1 and 2 and those of the method of manufacturing the display device according to the embodiment described above with reference to FIGS. 3, 4, 5, 6, and 7 will be omitted or simplified.

Referring to FIGS. 14, 15, and 16, the apparatus for manufacturing the display device according to another embodiment may be substantially the same as the display device manufacturing apparatus according to the embodiment described above except for a configuration of a bonding device TL′. In an embodiment, the chucking part FX′ included in the bonding device TL′ may include only one chuck (e.g., the first chuck CK1) and the bracket BR supporting the chuck CK1.

In an embodiment, the chuck may chuck a portion (e.g., one end) of the second film F2. While the part of the second film F2 is chucked by the chucking part FX′, the bonding device TL′ may be moved up/down to effectively prevent the sagging and the slip of the second film F2.

In such an embodiment where only one chuck is included, a manufacturing cost may be reduced compared to a case where two chucks are included, and interference with other parts may be more easily avoided.

The method of manufacturing method the display device according to the embodiment using the apparatus for manufacturing the display device according to the embodiment shown in FIGS. 14, 15, and 16 may be substantially a same/similar to the method of manufacturing the display device according to the embodiment described above.

In such an embodiment, for example, similar to those shown in FIGS. 3, 4, 5, 6, and 7, the object to be processed OB may be located on the stage ST (S100). The first film F1 may be located above the object to be processed OB (S200). The partially chucked second film F2 may be located above the first film F1 (modification of S300). Here, only the one end of the second film F2 may be chucked (refer to FIG. 14). The first film F1 and the second film F2 may be brought into contact with the object to be processed OB by pressing (S400). The second film F2 may be separated from the object to be processed OB (S500).

In such an embodiment where only the one end of the second film F2 is chucked, the manufacturing cost (e.g., vacuum formation cost, or the like) may be reduced compared to a case where opposite ends of the second film F2 are chucked.

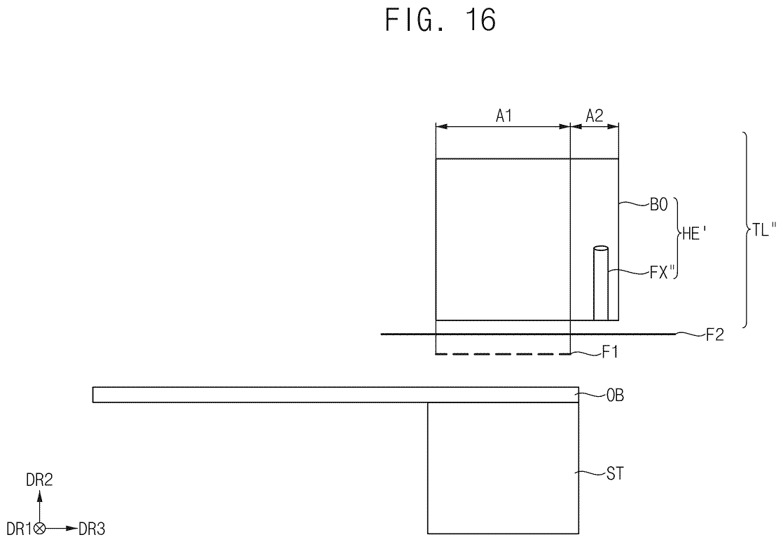

FIGS. 16, 17, and 18 are views illustrating the apparatus for manufacturing the display device and the method of manufacturing the display device using the apparatus according to another embodiment of the disclosure.

Hereinafter, for convenience of description, any repetitive detailed descriptions of the same or like elements as those of the apparatus for manufacturing the display device according to the embodiment of the disclosure described above with reference to FIGS. 1 and 2, those of the method of manufacturing the display device according to the embodiment described above with reference to FIGS. 3, 4, 5, 6, and 7, and those of the apparatus and the method of manufacturing the display device according to the embodiment described above with reference to FIGS. 14, 15, and 16 will be omitted or simplified.

Referring to FIGS. 16, 17, and 18, the apparatus for manufacturing the display device according to another embodiment may be substantially the same ass the apparatus for manufacturing the display device according to the embodiments described above except for a configuration of a bonding device TL″. In an embodiment, a head HE′ included in the bonding device TL″ may include a chuck FX″.

In an embodiment, the head HE′ may include a body BO and the chuck FX″. The chuck FX″ may be a vacuum chuck that is disposed inside the body BO and provides a vacuum suction force to the second film F2. However, the disclosure is not limited thereto. In an embodiment, for example, the chuck FX″ may be a variety of chucks capable of maintaining the tension of the second film F2. In an embodiment, for example, the chuck may include an electrostatic chuck.

In an embodiment, the body part BO may include a first region A1 and a second region A2. The first region A1 may be defined as a region overlapping the first film F1. The second region A2 may be defined as a region that does not overlap the first film F1. In an embodiment, the chuck FX″ (e.g., the vacuum chuck) may be disposed in the second region A2.

In an embodiment, the head HE′ and the second film F2 may not contact each other, and the chuck FX″ and the second film F2 may also not contact each other.

In an embodiment, the object to be processed may include the display panel included in the display device.

In an embodiment, the first film may be the anisotropic conductive film, and the second film may be the protective film.

In other words, the apparatus for manufacturing the display device according to the embodiment shown in FIGS. 16, 17, and 18 includes the head HE′ and the chuck FX″, and the apparatus for manufacturing the display device according to the embodiments described above may be substantially the same as the embodiment shown in FIGS. 16, 17, and 18 except that the head HE and the chucking parts FX and FX″ are independently configured.

In an embodiment, the chuck FX″ may chuck the portion (e.g., the one end or the opposite ends) of the second film F2. In case that the portion of the second film F2 is chucked, the bonding device TL″ may be moved up/down to effectively prevent the sagging and the slip of the second film F2.

In an embodiment where the chuck FX″ is merged with the head HE′, the bracket (e.g., the bracket BR of FIG. 2) may not be included. Accordingly, installation may be easier than in case that the head HE and the chucking part FX, FX″ are configured independently.

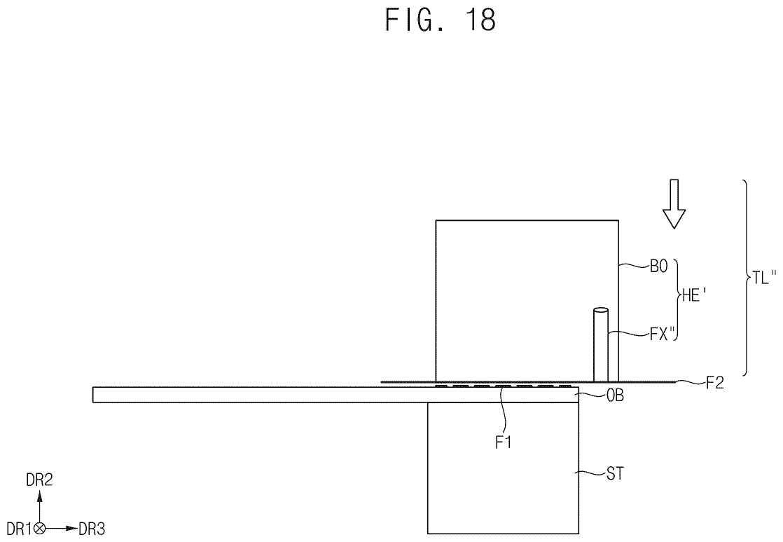

In the method of manufacturing the display device according to an embodiment using the apparatus manufacturing the display device according to an embodiment, as shown in FIG. 16, the object to be processed OB may be located on the stage ST. The first film F1 may be located above the object to be processed OB. The second film F2 may be located above the first film F1. Here, the second film F2 may not contact the head HE′ and the chuck FX″ when the first film F1 is located above the object to be processed OB. Accordingly, the deformation of the second film F2 due to the heat of the head HE may be effectively prevented. As shown in FIG. 17, the bonding device TL″ may move in the first direction. Accordingly, the chuck FX″ may chuck the portion of the second film F2. As shown in FIG. 18, the bonding device TL″ may move secondarily. Accordingly, the first film F1 and the second film F2 may be pressed and come into contact with the object to be processed OB. Next, the second film F2 may be separated from the object OB to be processed. In this process, the chuck FX″ may be turned off. In an embodiment, for example, the vacuum chuck may be released.

However, the disclosure is not limited thereto. In another embodiment, for example, a cooling device capable of preventing the thermal deformation of the second film F2 is further included, and the bonding process may be performed while the second film F2 is in contact with the head HE′ and the chuck FX″.

In a case of an apparatus for manufacturing the display device according to a comparative example, the chucking part (FX, FX;) or the chuck (FX″) may not be included. In this case, the positional deviation to which the second film F2 is attached on the object to be processed OB may be large. The larger the positional deviation, an attachment position of the component (e.g., the circuit board, or the like) may further deviates from the designed position, and the display device may be determined to be defective.

The apparatus for manufacturing the display device according to embodiments may be applied to a manufacturing process of a display device included in a computer, a notebook, a mobile phone, a smartphone, a smart pad, a portable media player (“PMP”), a personal digital assistance (“PDA”), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An apparatus for manufacturing a display device, the apparatus comprising:
a stage;
a first film processing part which transfers a first film positioned above the stage in one direction;
a second film processing part which transfers a second film positioned above the first film in the one direction;
a head above on the second film, wherein the head moves in a direction closer to the stage to provide a pressing force to the first film and the second film; and
a chucking part which chucks a portion of the second film.

2. The apparatus for claim 1, wherein the chucking part includes a vacuum chuck.

3. The apparatus for claim 1, wherein the chucking part includes a first chuck which chucks a first end of the second film and a second chuck which chucks a second end of the second film opposite to the first end.

4. The apparatus for claim 1, wherein the chucking part includes only one chuck which chucks one of a first end of the second film and a second end of the second film opposite to the first end.

5. The apparatus for claim 1, wherein,
in a standby state where the head does not provide the pressing force to the first film and the second film,
the head and the second film do not contact each other, and
the chucking part and the second film contact each other.

6. The apparatus for claim 1, wherein,
an object to be processed is located on the stage, and
the object to be processed includes a display panel included in the display device.

7. The apparatus for claim 1, wherein,
the first film is an anisotropic conductive film, and
the second film is a protective film.

8. An apparatus for manufacturing a display device, the apparatus comprising:
a stage;
a first film processing part which transfers a first film positioned above the stage in one direction;
a second film processing part which transfers a second film positioned above the first film in the one direction; and
a head positioned above the second film, wherein the head moves in a direction closer to the stage to provide a pressing force to the first film and the second film, and the head includes a body part and a chuck disposed in a hole defined in the body part, wherein the chuck chucks a portion of the second film.

9. The apparatus for claim 8, wherein the chuck includes a vacuum chuck which provides a vacuum suction force to the second film.

10. The apparatus for claim 8, wherein,
the body part includes a first region and a second region,
the first region is defined as an area which overlaps the first film, and the second region is defined as an area which does not overlap the first film, and
the chuck is located in the second region.

11. The apparatus for claim 8, wherein,
in a standby state where the head does not provide the pressing force to the first film and the second film,
the head and the second film do not contact each other, and
the chuck and the second film do not contact each other.

12. The apparatus for claim 8, wherein,
an object to be processed is located on the stage, and
the object to be processed includes a display panel included in the display device.

13. The apparatus for claim 12, wherein,
the first film is an anisotropic conductive film, and
the second film is a protective film.

14. A method of manufacturing a display device, the method comprising:
disposing an object to be processed on a stage;
disposing a first film above the object to be processed;
disposing a second film, a portion of which is chucked, above the first film;
pressuring the first film and the second film to contact the object to be processed; and
separating the second film from the object to be processed.

15. The method of claim 14, wherein the portion of the second film is chucked by vacuum suction.

16. The method of claim 14, wherein the portion of the second film is opposite ends of the second film.

17. The method of claim 14, wherein the portion of the second film is one end of the second film.

18. The method of claim 14, wherein the object to be processed includes a display panel included in a display device.

19. The method of claim 18, wherein,
the first film is an anisotropic conductive film, and
the second film is a protective film.

20. The method of claim 14, wherein the first film is provided in plural, and a plurality of the first films are attached on the object to be processed.
